(19) United States
(12) Patent Application Publication
(10) Pub. No.: US 2008/0286024 A1
(43) Pub. Date: Nov. 20, 2008

(54) Image Data Generating Device, Tape Printer, Printing System, and Computer Program

(75) Inventor: Mikihiro KAJIHARA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/112,945

(22) Filed: Apr. 30, 2008

(30) Foreign Application Priority Data
May 14, 2007 (JP) 2007-128571

(51) Int. Cl. B41J 11/44

(52) U.S. Cl. 400/76

(57) ABSTRACT

Provided herein is an image data generating device generates a plurality of pieces of divided image data to be printed on each tape segment to form a printed image by putting a plurality of tape segments together on which a divided printed image being a part of the printed image larger than the width of each tape segment is printed, and includes: a display unit that displays a state where the printed image and the plurality of tape segments are overlapped and arranged; a tape-arrangement specifying unit that specifies an arrangement angle of each tape segment displayed on the display unit; a printed image allocating unit that allocates the divided printed image to each tape segment based on a specification made by the tape-arrangement specifying unit; and a divided image data generating unit that generates a plurality of divided image data based on a result allocated by the printed image allocating unit.

The entire disclosure of Japanese Patent Application No. 2007-128571, filed May 14, 2005, is expressly incorporated by reference herein.

### BACKGROUND

1. Technical Field

The present invention relates to an image data generating device, a tape printer, a printing system, and a computer program that generate a plurality of pieces of divided image data to be printed on each tape segment for forming a printed image by putting a plurality of tape segments together on which a part of the printed image is printed.

2. Related Art

A so-called “enlargement printing” that forms a printed image by putting a plurality of tape segments together in which a part of the printed image larger than the tape segment is printed thereon is heretofore known (see JP-A-11-157136). A device with the “enlargement printing” forms a printed image by putting printed tape segments having the same length together in parallel in which a part of the printed image is respectively printed thereon.

However, in the above method, no problems occur when the printed image has simple shape such as square or rectangular, whereas triangular or circular printed image results in non-printed area having no printed image. FIG. 15 is an example of how to put four tape segments T together when a printed image G having triangular shape is enlarged and printed, where a shaded area 201 is the non-printed area. Particularly in the case of enlargement printing, because the printed image G is cut with scissors along the circumference thereof (see an alternate long and short dashed line LO in FIG. 15) to use the cut-off printed image portion, parts of tape having the non-printed area is discarded as waste.

In addition, types of tape such as a colored tape and a patterned tape is widely varied in recent years, accordingly, there is a need to provide a desired shape with tapes. FIG. 16A is an example showing how to put tape segments T together to represent a triangle. FIG. 16B is another example showing how to put a printed image G and tape segments T together to represent a triangle. However, there is the only way to prepare a blank tape having a certain length and put them onto each other as shown in FIG. 16A because a current “enlargement printing” is assuming that tape segments are put together in parallel onto each other, and further what FIG. 16B shows is unfeasible.

### SUMMARY

An advantage of some aspects of the invention is to provide an image data generating device, a tape printer, a printing system, and a computer program, which can reduce waste tape in the case of enlargement printing, and also easily accomplish a wide variety of examples of how to put tapes together.

According to one aspect of the invention, an image data generating device that generates a plurality of pieces of divided image data to be printed on each tape segment to form a printed image by putting a plurality of tape segments together on which a divided printed image being a part of the printed image larger than the width of each tape segment is printed includes a display unit that displays a state where the printed image and the plurality of tape segments are overlapped and arranged, a tape-arrangement specifying unit that specifies an arrangement angle of each tape segment displayed on the display unit, a printed image allocating unit that allocates the divided printed image to each tape segment based on a specification made by the tape-arrangement specifying unit, and a divided image data generating unit that generates a plurality of divided image data based on a result allocated by the printed image allocating unit.

With this configuration, the arrangement angle of each tape segment can be specified while the state where the printed image and the plurality of tape segments are overlapped and arranged can be checked on the display unit. Therefore, even when the printed image such as a triangle or a circle is formed, the arrangement can be easily specified and reduced waste tape by arranging the tape segments along the outline of the printed image. This allows representing the image area with the tape segments, thereby easily accomplishing a wide variety of examples of how to put them together In this case, the printed image remains on the display unit to represent a desired shape with the printed image and the tape, while the printed image is deleted from the display unit to represent a desired shape only with the tape.

It is preferable that in the image data generating device, the tape-arrangement specifying unit be capable of specifying the arrangement angle of each tape segment and the tape length of each tape segment, and the tape segment is prepared by printing on and cutting an elongated tape based on the divided image data including information on the specified tape length.

With this configuration, the invention is applicable to a case where the tape segment is prepared by cutting an elongated tape. Furthermore, the tape length can be specified to easily provide a wider variety of example of how to put such tapes together, while the unnecessary use of tapes can be reduced to achieve further reduction in waste tapes.

It is preferable that in the image data generating device, the display unit include a preview area that previews a result generated by the divided image data generating unit for each tape segment.

With this configuration, the print result of each tape segment can be checked by referring to the preview. Furthermore, the preview allows to check to which part of the printed image the tape segment corresponds, and distinguish between the top and the bottom of the tape segment, thus such tape segments can be easily put together.

It is preferable that in the image data generating device, the tape-arrangement specifying unit include an overlap reordering unit that changes, when a part of the plurality of tape segments is specified to be overlappingly arranged, the overlapping order of the overlapped part thereof by the specification of an overlapped part.

With this configuration, the overlapping order of the overlapped parts of the tape segments can be changed according to the user preference or the shape of an object to which such tape segments are put, for example.

It is preferable that in the image data generating device, the display unit display a border between a printable area and an unprintable area of each tape segment.

With this configuration, the unprintable area is recognized to specify the arrangement of each tape segment. In other words, a user can recognize beforehand that a part of the printed image such as an image section around an edge of a tape segment on the upper side of the overlapped part may be missed because of the unprintable area. The term “unprintable area” refers to an area that is produced by the structure of the printing mechanism or the cutting mechanism on the device side that prints partial image data and unable to be printed, whereas the “printable area” is the area other than the “unprintable area”.

It is preferable that the image data generating device further include a print instructing unit that instructs to print a plurality of divided image data generated by the divided image data generating unit, and a divided image data outputting unit that outputs the plurality of divided image data according to an instruction made by the print instructing unit.

With this configuration, print can be instructed by the image data generating device side to output the divided image data to an external device that executes printing.

It is preferable that in the image data generating device, when a part of the plurality of tape segments is specified to be overlappingly arranged by the tape-arrangement specifying unit, the divided image data outputting unit determine an outputting order of the divided image data according to the overlapping order of overlapped parts of the tape segments.

With this configuration, the divided image data can be output in the overlapping order of lowest (at the backmost) to highest to put tape segments together in the printing order. This allows to shorten a waiting time since there is no need to wait to print all tape segments, and put tape segments together in the correct order, whereby the problem in that a desired printed image cannot be reproduced because of the erroneous order to put tape segments together can be solved.

It is preferable that in the image data generating device, the tape-arrangement specifying unit be capable of specifying the arrangement angle of each tape segment and the tape width of each tape segment, and the divided image data outputting unit further includes a tape switching informing unit that determines the outputting order of each divided image data according to the tape width specified by the tape-arrangement specifying unit and informs that the tape width of the divided image data output by the divided image data outputting unit is switched, when switching the tape width.

With this configuration, the tape width can be specified according to the user preference or the shape of the printed image, for example When the divided image data is output to the external device that requires replacement of tapes for each tape width, because information on switching the tape width is informed when switching the tape width, the user can replace tapes according to the information, which is convenient on the printing operation.

According to another aspect of the invention, a tape printer of the invention creates a plurality of tape segments based on a plurality of divided image data generated by the image data generating device with any one of the above-described features.

According to a further aspect of the invention, a printing system of the invention includes the image data generating device with any one of the above-described features and a tape printer that creates the plurality of tape segments based on the plurality of divided image data generated by the image data generating device.

According to a still further aspect of the invention, a computer program of the invention causes a computer to function as each unit in the image data generating device with any one of the above-described features.

This configuration can reduce waste tapes in the case of enlargement printing, and also provide a wide variety of examples of how to put tapes together

### BRIEF DESCRIPTION OF THE DRAWINGS

The invention will be described with reference to the accompanying drawings, wherein like numbers reference like elements.

FIG. 1 is a schematic diagram of a printing system according to one embodiment of the present invention.

FIG. 2 is a block diagram of an image data creating device.

FIG. 3 is a schematic diagram of an editing screen.

FIG. 4 is an appearance perspective view in which a lid of a tape printing device is closed.

FIG. 5 is an appearance perspective view in which the lid of the tape printing device is opened.

FIG. 6 is a block diagram of the tape printing device.

FIGS. 7A and 7B are exemplary views of an editing operation using the editing screen.

FIGS. 8A and 8B are exemplary views of the editing operation using the editing screen following FIGS. 7A and 7B.

FIGS. 9A and 9B are exemplary views of the editing operation using the editing screen following FIGS. 7A, 7B, 8A and 8B.

FIGS. 10A and 10B are exemplary views of the editing operation using the editing screen following FIGS. 7A, 7B, 8A, 8B, 9A and 9B.

FIGS. 11A and 11B are exemplary views of the editing operation using the editing screen following FIGS. 7A, 7B, 8A, 8B, 9A, 9B, 10A and 10B.

FIG. 12 is a flowchart showing an image data generating process of the image data creating device.

FIGS. 13A to 13C are views showing a production example of tape segments to which the invention is applied.

FIG. 14 is a view showing a printing order of the tape segments based on the tape width.

FIG. 15 is a view showing a related art.

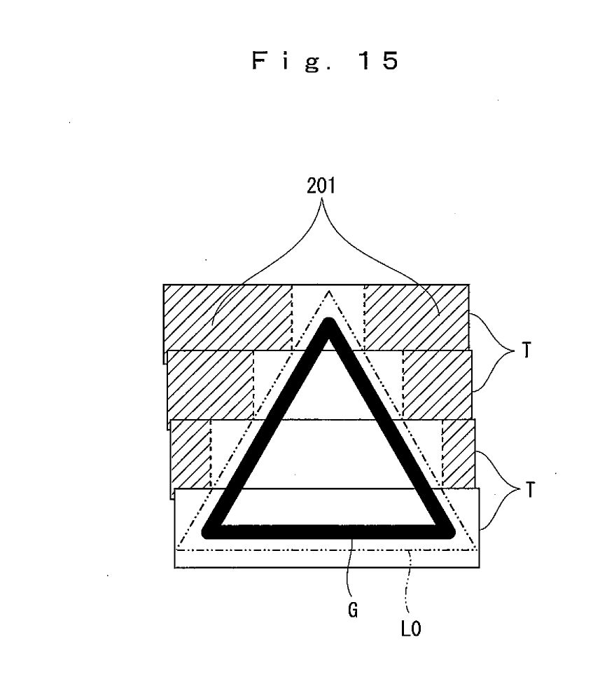

FIGS. 16A and 16B are views showing the related art.

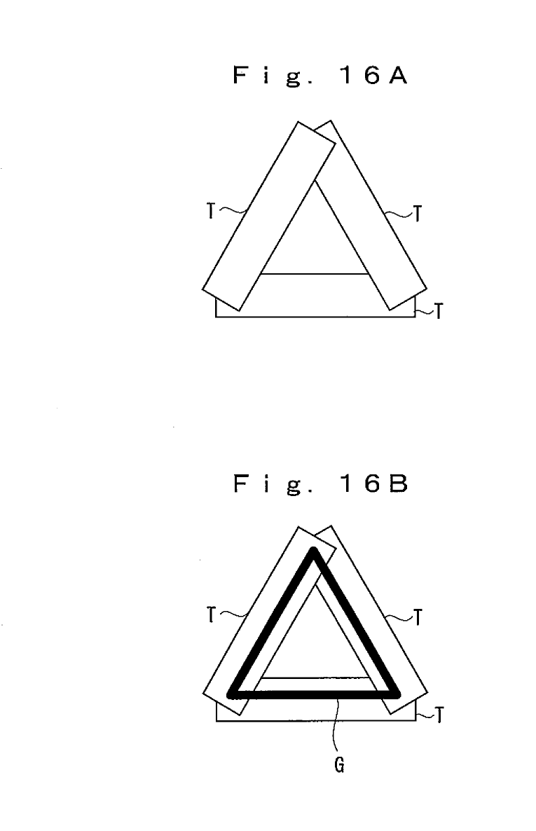

### DESCRIPTION OF EXEMPLARY EMBODIMENTS

An image data generating device, a tape printing device, a printing system, and a computer program according to embodiments of the invention will be described with reference to the accompanying drawings.

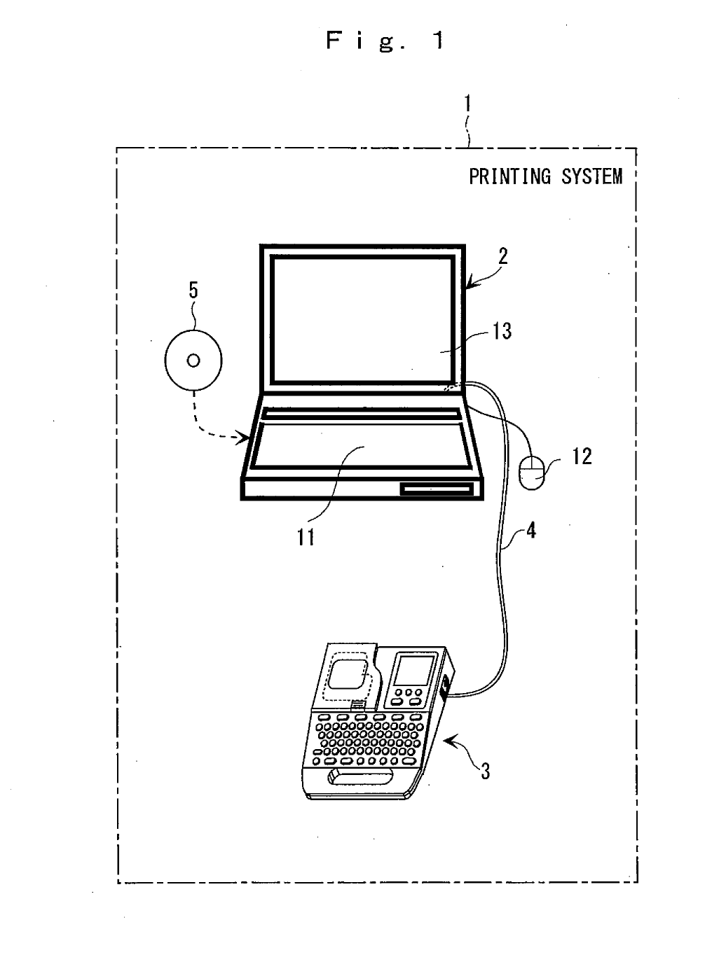

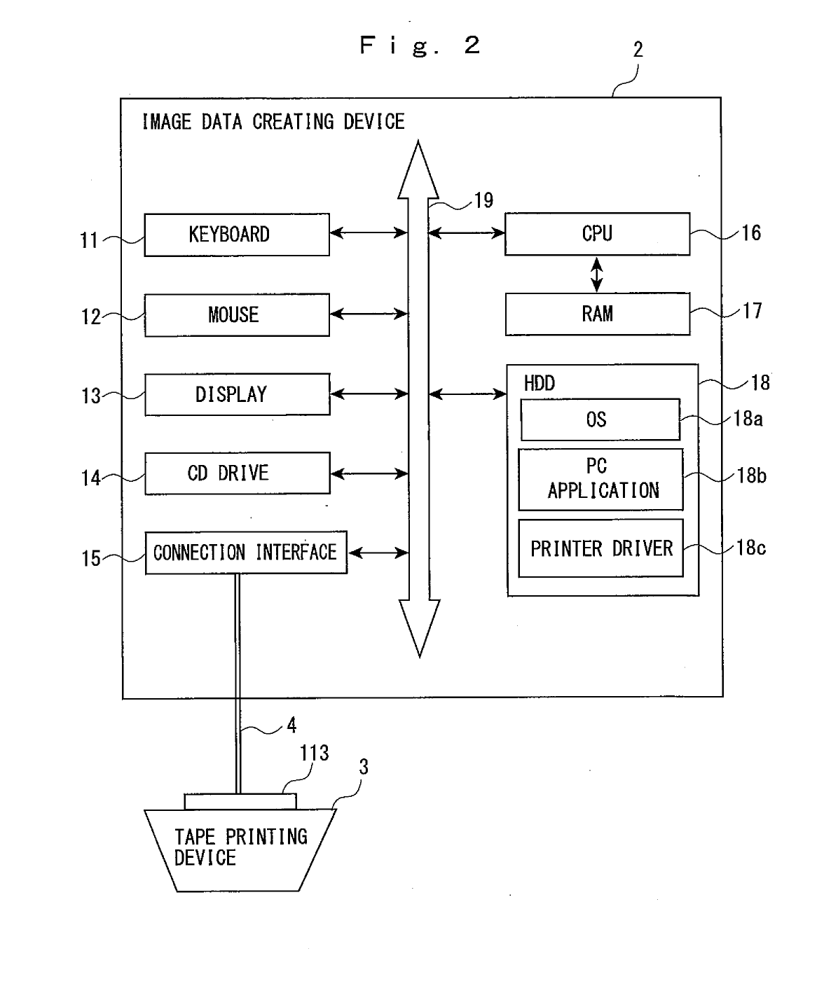

Referring to FIG. 1, a printing system 1 is schematically shown. As shown in FIG. 1, the printing system 1 includes an image data creating device 2 and a tape printing device 3, both of which are mutually connected via a cable 4. A generic personal computer having a keyboard 11, a mouse 12, a display 13 or the like is available for the image data creating device 2. That is, the personal computer can be caused to function as the image data creating device 2 of the embodiment by installing a PC application 18b and a printer driver 18c (see FIG. 2) thereon stored in a CD-ROM 5.

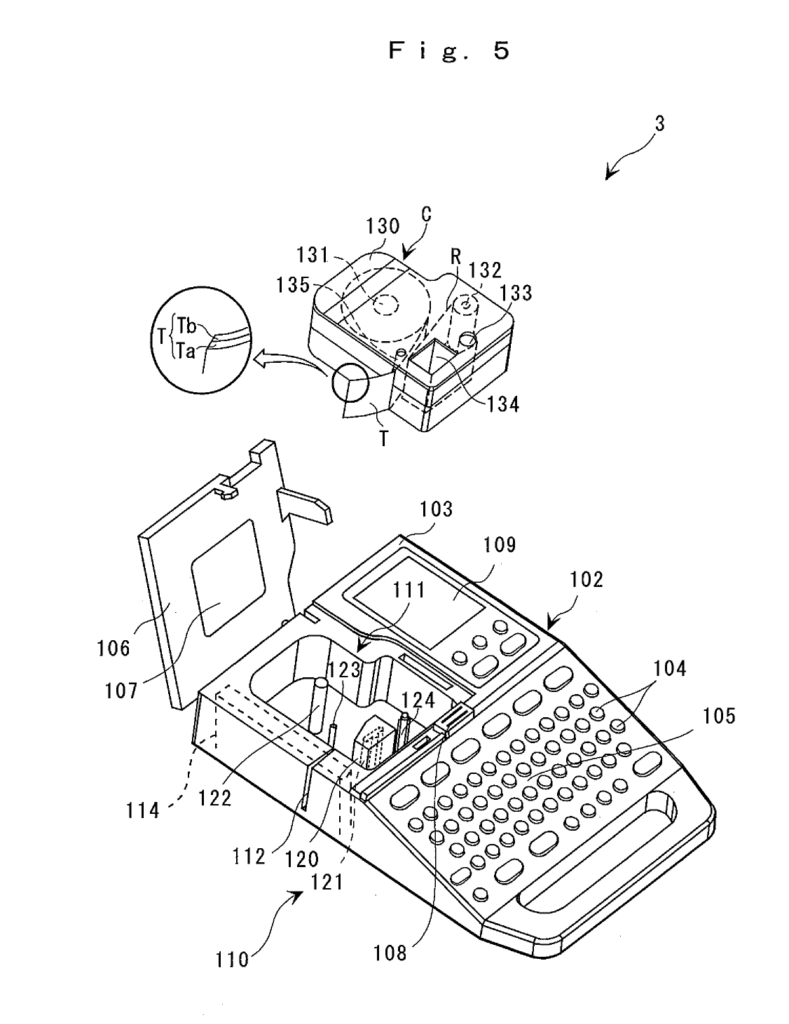

The tape printing device 3 uses an elongated tape T (see FIG. 5) as printing medium and prepares a tape segment (label) by printing on and cutting the tape T based on image data obtained from the image data creating device 2.

In the embodiment, the configuration in which the image data creating device 2 and the tape printing device 3 are directly connected to each other via the cable 4 is exemplified, however, the data creating device 2 and the tape printing device 3 may be connected via a network such as the Internet and a local area network, or otherwise through a wireless communication.

Next, referring to FIG. 2, a controlling structure of the image data creating device 2 will be described. The image data creating device 2 includes a CD drive 14, a connection interface 15, a CPU 16, a RAM 17, a hard disk (HDD) 18 and a connection bus 19 that mutually connects these components, in addition to the keyboard 11, the mouse 12 and the display 13 as shown in FIG. 1.

The CD drive 14 reads data stored in the CD-ROM 5, and is used for installing of the PC application 18b and the printer driver 18c in the embodiment. The CD-ROM 5 is provided to a user as an accessory of the tape printing device 3. The connection interface 15 is a connection port to connect a connector 113 of the tape printing device 3 thereto via the cable 4, and uses a USB interface in the embodiment

The CPU 16 controls the entire image data creating device 2 by computing various kinds of data. The RAM 17 directly connects to the CPU 16 without the connection bus 19, and is used for a work area when the CPU 16 executes various processings.

The hard disk 18 stores an operating system (OS) 18a, as well as the PC application 18b and the printer driver 18c which are read from the CD-ROM 5. The PC application 18b is application software to be incorporated in the operating system 18a to be used, and includes processing programs to execute various processings such as editing of the tape segment T and a printed image G, and instructing to print, as will be described later. The printer driver 18c mediates between the operating system 18a and the tape printing device 3.

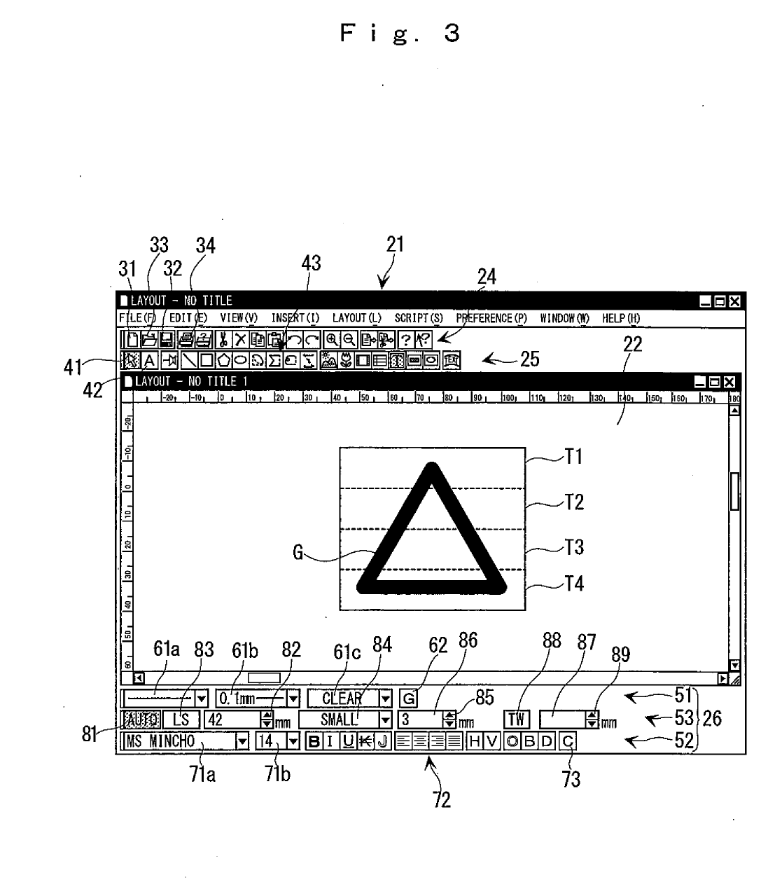

Now referring to FIG. 3, an editing screen 21 displayed on the display 13 in order that a user edits an image of a tape segment T (hereinafter simply referred to as a “tape segment T”) and the printed image G will be described. The editing screen 21 displays an editing area 22 that edits the tape segment T and the printed image G, a basic operation toolbar 24 that performs basic operations, an input toolbar 25 that inputs characters and graphics as input data, and an edit toolbar 26 that edits the input data.

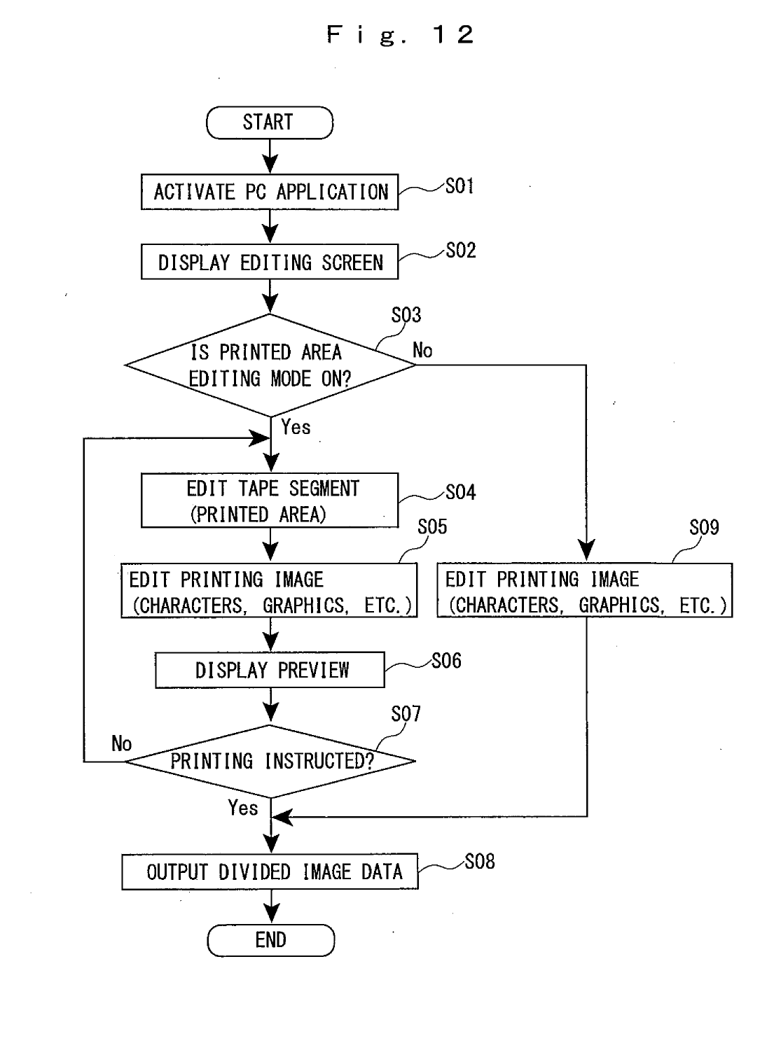

In the editing area 22, the user overlaps and arranges the tape segment T and the printed image G so as to allocate a part of the printed image G to each tape segment T. An exemplary diagram in FIG. 3 shows a case of enlargement printing of the printed image G representing a triangle by using four tape segments T1 to T4. Here, an editing example in which the four tape segments T1 to T4 having the same width and the same length are mutually adhered without any gaps in parallel to form the printed image G (No at S03 in a flowchart on FIG. 12 (a case where a print editing area mode is not set)) is shown, however, the image data creating device 2 of the embodiment can specify any length and any arrangement angle of each tape segment T in the print editing area mode, thereby waste tape can be reduced in the case of the enlargement printing, and also accomplished a wide variety of examples of how to put tapes together Details thereof will be described later with reference to the specific examples.

The basic operation toolbar 24 includes a new page button 31 that newly creates print data, a save button 32 that saves the created print data, a read button 33 that reads the saved image data to display the data on the editing area 22, and a print button 34 that causes the image data creating device 2 to print based on the edit result displayed on the editing area 22.

The input toolbar 25 includes an object selecting button 41 that selects objects such as the tape segment T and the printed image G, a character input button 42 that inputs characters, and various graphical input buttons 43 that input lines and graphics, and the like.

The edit toolbar 26 is composed of a graphical toolbar 51 that edits input graphics, a character toolbar 52 that edits the input characters and a label creating toolbar 53 that creates a label (the tape segment T) by the tape printing device 3. The graphical toolbar 51 is composed of three list boxes 61a, 61b and 61c (pull-down menus) each of which selects and sets a type, thickness, and filling of outline of graphics from and to a plurality of options, and a graphical setting window display button 62 that causes the image data creating device 2 to display a window to perform various settings for graphics.

The character toolbar 52 includes list boxes 71a and 71b (pull-down menus) each of which selects and sets a font and a size of the input character, various 14 setting buttons 72 that perform settings for a style (bold, italic, underlined etc.) of the input characters, layout (e.g. centering, right-aligned), horizontal or vertical, and character decoration (outline, border, etc.), and a character setting window display button 73 that causes the image data creating device 2 to display a window to perform various settings for the input characters.

The label creating toolbar 53 includes an automatic setting button 81 that automatically sets the length of the tape segment T to be created depending on the shape or size of the printed image G, a length setting button 83 that sets the length of the tape segment T to be created to a predetermined length selected by a scroll bar 82, a margin setting list box 84 that selects and sets a vertical length of margin-bottom of the printed image G from short, medium, and long, a margin setting box 86 that sets a numeric value in a length of the margin by a scroll bar 85 same as the above, and a tape-width acquiring button 88 that acquires the tape width of the tape T mounted in the tape printing device 3 (through a communication with the tape printing device 3) (as will be described later) to display the tape width in a tape-width display box 87. The tape-width display box 87 incorporates a scroll bar 89, and also enables to manually input the tape width.

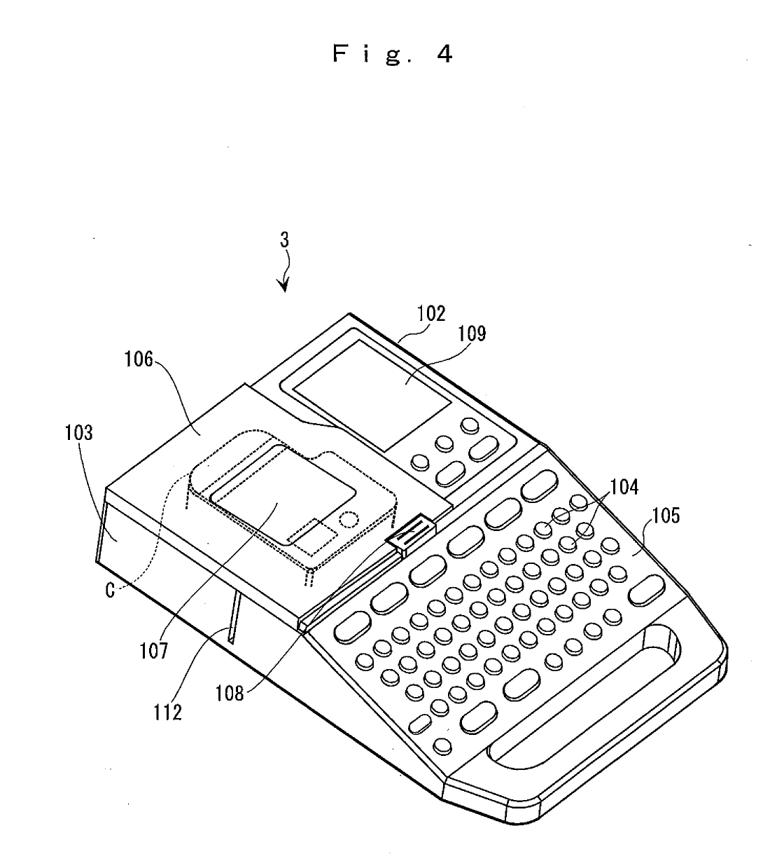

Next, referring to FIGS. 4 and 5, a device configuration of the tape printing device 3 will be described. The tape printing device 3 includes a device body 102 that performs print processing on the tape T and a tape cartridge C that houses the tape T and an ink ribbon R and is detachably mounted in the device body 102.

A device casing 103 forms a shell on the device body 102, and a print processing section 110 is configured extensively inside the casing. A keyboard 105 having various keys 104 is disposed on the front surface of the device casing 103. An opening/closing lid 106 is extensively provided on the top left of the back of the device casing 103, on which an observation window 107 is formed for viewing whether the cartridge C is mounted/demounted; and a lid opening button 108 is provided in the front side of the opening/closing lid 106 to open it. A rectangular display 109 that displays an input result etc. from the keyboard 105 is formed on the top right of the back of the casing.

When the lid opening button 108 is pressed to open the opening/closing lid 106, a cartridge mounting section 111 that mounts the tape cartridge C is recessed and formed thereunder, and a print head 121 that performs print processing on the tape T unwound from the tape cartridge C is disposed in the cartridge mounting section 111 (see FIG. 5).

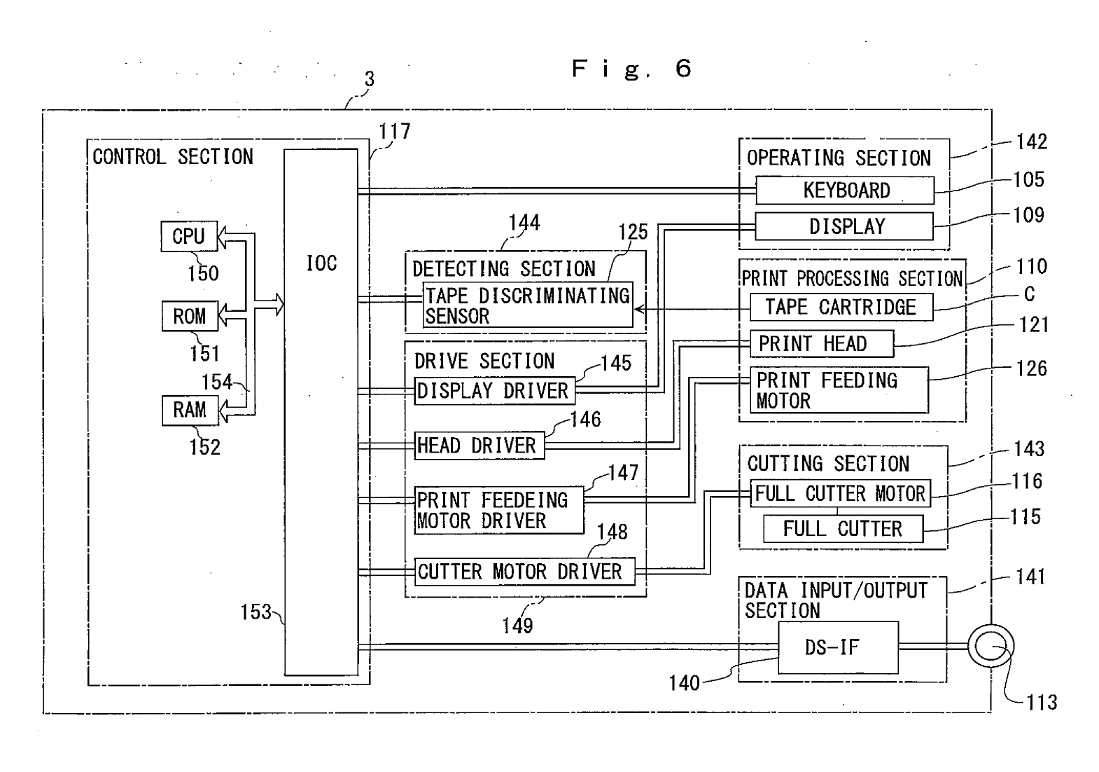

A tape ejecting slot 112 that communicates between the cartridge mounting section 111 and outside the device is formed on the left side of the device casing 103, and a cutter unit 114 that cuts off the tape T is embedded in the device casing 103, facing the tape ejecting slot 112. The cutter unit 104 is so disposed as to face the tape ejecting slot 112 and includes a full cutter 115 that cuts off the tape T like scissors with a motor drive (a full cutter motor 116), and an ejecting mechanism that is disposed downstream of the tape-feeding direction with respect to the full cutter 115 and forcibly ejects the cut tape segment T (see FIG. 6).

Although not shown, a power supply port for supplying power and a connector 113 for connection to an external device such as the image data creating device 2 (see FIG. 2) are formed on the right side of the device casing 103. A circuit board that constitutes a control section 117 to collectively control the device body 102 (see FIG. 6) is incorporated in the device casing 103.

The print head 121 having a heater element and covered with a head cover 120, a positioning boss 122 that positions a tape reel 131 as will be described later, a platen drive shaft 123 that feeds the tape T of the tape cartridge C and the ink ribbon R and faces against the print head 121, and a take-up drive shaft 124 that takes up the ink ribbon R, all of which are projectedly provided in the cartridge mounting section 111; and a tape discriminating sensor 125 composed of a plurality of microswitches is provided on the periphery of the cartridge mounting section 111 (see FIG. 6). A print-feeding motor 126 that drives the platen drive shaft 123 and the take-up drive shaft 124 (see FIG. 6), a reduction gear train (not shown) or the like are embedded in the bottom plate of the cartridge mounting section 111.

The tape cartridge C has a cartridge case 130 that houses the tape reel 131 that winds the tape T, a ribbon unwinding reel 132 and a ribbon take-up reel 133 each of which winds the ink ribbon R at the bottom right. A through aperture 134 for inserting to the head cover 120 covering the print head 121 is formed at the bottom left of the tape reel 131. Furthermore, a platen roller 135 that fits into the platen drive shaft 123 to be rotatably driven is so placed as to correspond to a part where the tape T and the ink ribbon R overlap.

When the tape cartridge C is mounted in the cartridge mounting section 111, the through aperture 134, the tape reel 131, the ribbon take-up reel 133 and the platen roller 135 are inserted into the head cover 120, the positioning boss 122, the take-up drive shaft 124 and the platen drive shaft 123, respectively, and in this state, the opening/closing lid 106 is closed to cause the print head 121 to draw the tape T and the ink ribbon R to abut the platen roller 135, resulting in a print stand-by state. Then, the platen drive shaft 123 and the take-up drive shaft 124 are synchronously rotated based on the image data transmitted from the image data creating device 2 to perform print processing by the print head 121 while feeding the tape T and the ink ribbon R. Concurrently, the ink ribbon R fed by the ribbon feeding reel 132 goes around the periphery of the aperture wall of the through aperture 134 to be wound on the ribbon take-up reel 133. The printed tape T is cut by the full cutter 115 to eject the cut tape segment T from the tape ejecting slot 112 to the outside thereof.

The tape T is composed of a recording tape Ta in which an adhesive agent layer is applied on the back surface and a peeling tape Tb applied to the recording tape Ta by the adhesive agent layer. Also, the tape T is wound into roll in which the recording tape Ta and the peeling tape Tb faces outside and inside, respectively, to be housed in the cartridge case 130. A plurality of tape widths from 6 mm to 24 mm is prepared for the tape T. A plurality of small detected holes (not shown) are formed on the back surface of the cartridge case C so that the detected holes are discriminated by the tape discriminating sensor 125 to identify the type of the tape T (e.g. width, material, design, color and the like of the tape T).

Next, referring to FIG. 6, a controlling structure of the tape printing device 3 will be described. The tape printing device 3 is configured with a data input/output section 141, an operating section 142, the print processing section 110, a cutting section 143, a detecting section 144, a drive section 149, and the control section 117 that connects to respective sections and controls the entire tape printing device 3.

The data input/output section 141 has a data supply interface (DS-IF) 140, and inputs the image data from the image data creating device 2 via the connector 113 while inputting/outputting various commands and statuses. The operating section 142 has the keyboard 105 and the display 109, and is responsible for controlling a user interface, e.g. inputting character information by a user and displaying various information.

The print processing section 110 has the tape cartridge C, the print head 121 and the print-feeding motor 126, and prints the character information and the image data input to or received on the tape T while feeding the tape T and the ink ribbon R. The cutting section 143 has the full cutter 115 and the full cutter motor 116 that drives them, and full cuts the printed tape T.

The detecting section 144 has sensors such as a rotational speed sensor (not shown) that detects a rotational speed of the print-feeding motor 126 in addition to the tape discriminating sensor 125, and performs various detections. The drive section 149 has a display driver 145, a head driver 146, a print-feeding motor driver 147 and a cutter motor driver 148, and drives respective sections.

The control section 117 includes a CPU 150, a ROM 151, a RAM 152 and an input output controller (IOC) 153, and all of which are interconnected via an internal bus 154. The CPU 150 inputs various signals/data from respective sections of the tape printing device 3 via the IOC 153 based on the control program in the ROM 151. Also, the CPU 150 controls print processing and the like by processing various data in the RAM 152 based on the various signals/data that is input, and outputting the various signal data to the respective sections of the tape printing device 3 via the IOC 153. For example, the CPU 150 expands the image data into bitmap data to temporally store in the buffer in the RAM 152 when acquiring image data from the image data creating device 2 via the data supply interface 140. Then, the CPU 150 transmits a command to the drive section 149 to drive the print head 121 and the print-feeding motor 126 to perform print processing, and further transmits a command to the drive section 149 to drive the full cutter motor 116 to perform cut processing, thereby creating the printed tape segment T.

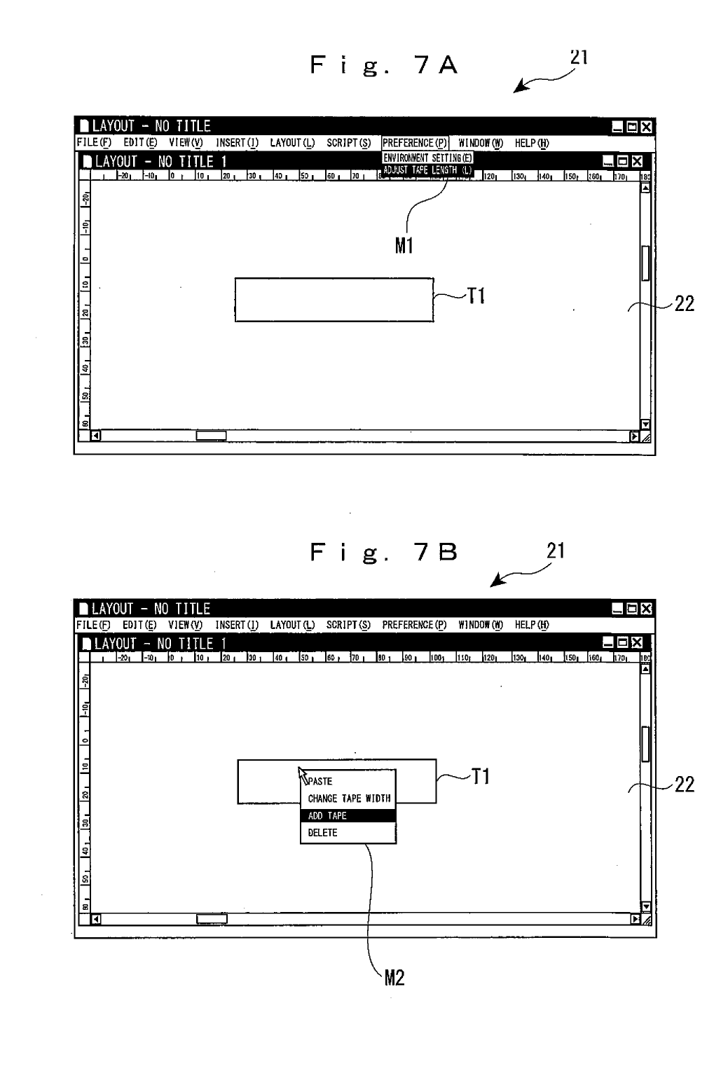

Next, referring to FIGS. 7A to 11B, an editing operation using the editing screen 21 of the image data creating device 2 will be described. In FIGS. 7A to 11B, an description of the basic operation toolbar 24, the input toolbar 25 and the edit toolbar 26 (see FIG. 3 for all) included in the editing screen 21 will be omitted.

First, an editing operation of the tape segment will be described. As shown in FIG. 7A, “edit printed area” is selected from a setting menu M1 to set to a printed area editing mode. In the printed area editing mode, the tape segment T1 having the tape width displayed on the tape-width display box 87 of the editing screen 21 (see FIG. 3) and a predetermined length corresponding to the tape width is displayed.

If the printed area editing mode is not selected, a plurality of tape segments T having a length corresponding to a lateral length of the printed image G is juxtaposed in parallel according to specification of enlargement printing to create divided image data for printing a divided printed image on each tape segment T based on the arrangement of the printed image G and each tape segment T, as shown in FIG. 3. That is, a tape length and arrangement of each tape segment T is automatically set depending on the printed image G.

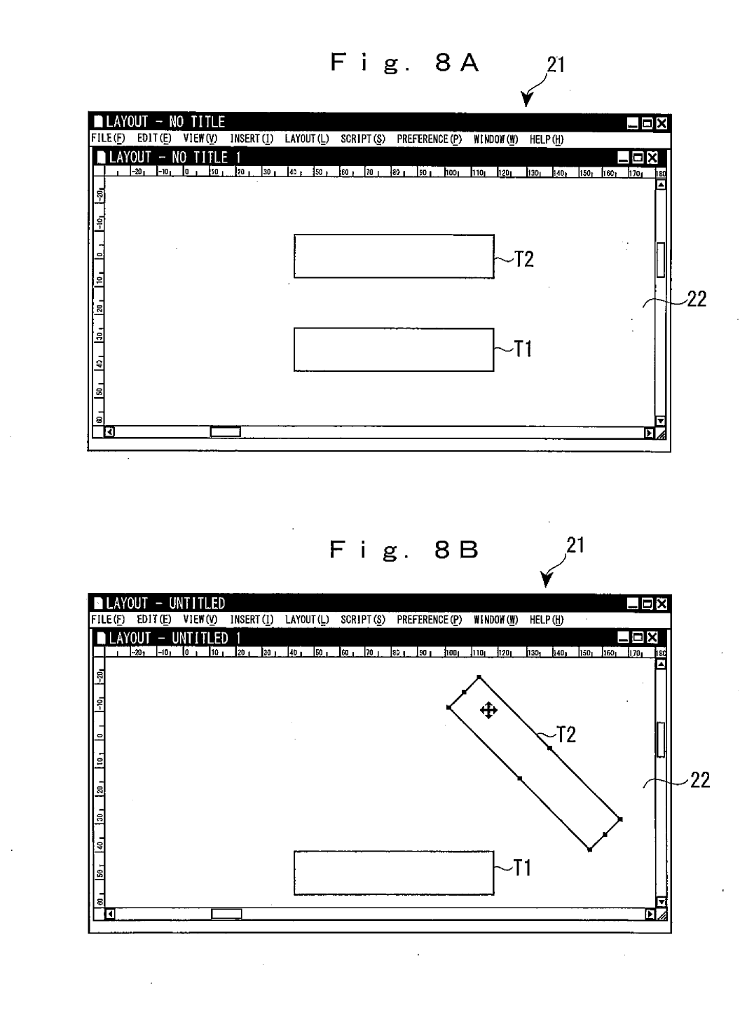

As shown in FIG. 7B, in the printed area editing mode, the mouse 12 is right-clicked with a mouse pointer on the tape segment T to display a right-click menu M2. “Add tape” is selected from the right-click menu M2 to display a new tape segment T2 on the editing area 22, as shown in FIG. 8A. If “paste” is selected from the right-click menu M2, a tape segment cut off last time can be pasted on the editing area 22 (not shown). “Tape width” is selected from the right-click menu M2 to further display options for the tape width such that a user can change a tape width selected by the user therefrom.

An arrangement of the two tape segments T1 and T2 shown in FIG. 8A can be specified by individually changing the arrangement angle (rotating or dragging the tapes, as shown in FIG. 8B. Furthermore, although not specifically shown, the length of the tape segment T can be adjusted by dragging a certain mark arranged around the tape segment T1.

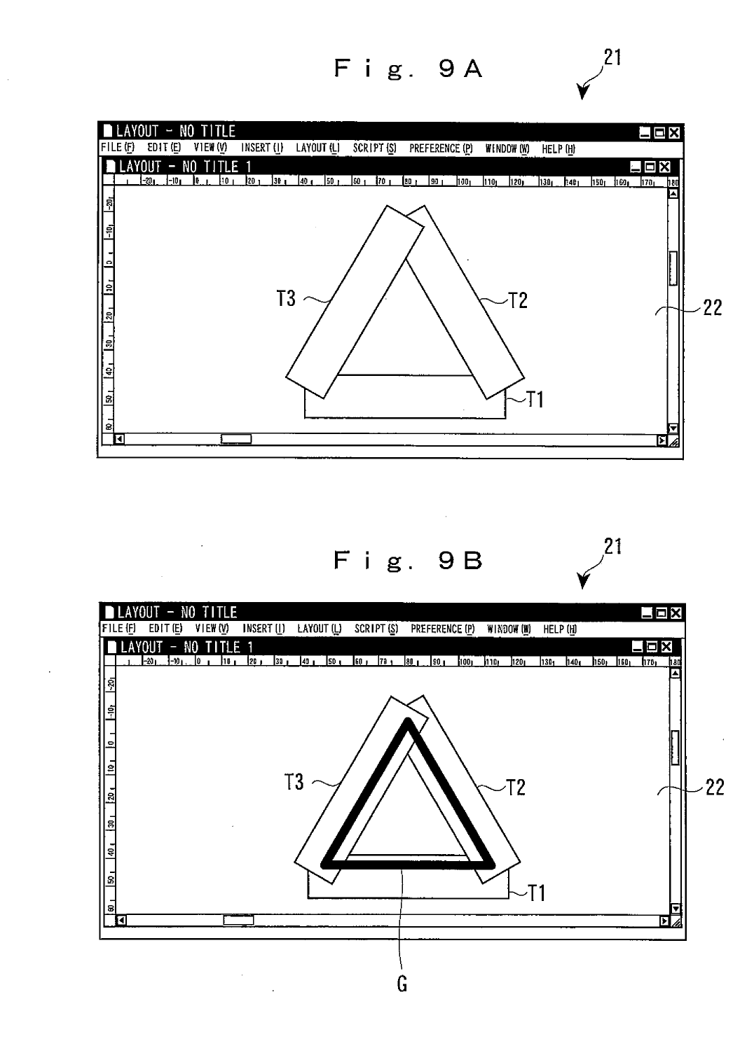

FIG. 9A shows an arranged state of tape segments T where the tape segment T1 is moved up and the tape segment T2 is moved to the left side from the state shown in FIG. 8B, so that the lower end thereof is brought into contact with the tape segment T1, then adding a new tape segment T3 such that a triangle is represented with the three tape segments T1, T2 and T3. According to the above operations, the tape segment T is edited. If a print action is instructed in the state shown in FIG. 9A, blank tapes T1, T2 and T3 will be created. In other words, when the user desires to represent a shape only with tapes, the user only edits a tape segment T to instruct a print action.

Then, an editing operation of the printed image G will be described. The user creates the printed image G to overlap and arrange the created printed image G on the tape segments T while imagining the resultant label. FIG. 9B shows a state where the triangular printed image G created by the user is overlapped and arranged on the tape segments T1, T2 and T3 each of which are arranged in FIG. 9A. The printed image G may be not only a shape only having outline of an image as shown, but also a shape having an image area filled inside thereof.

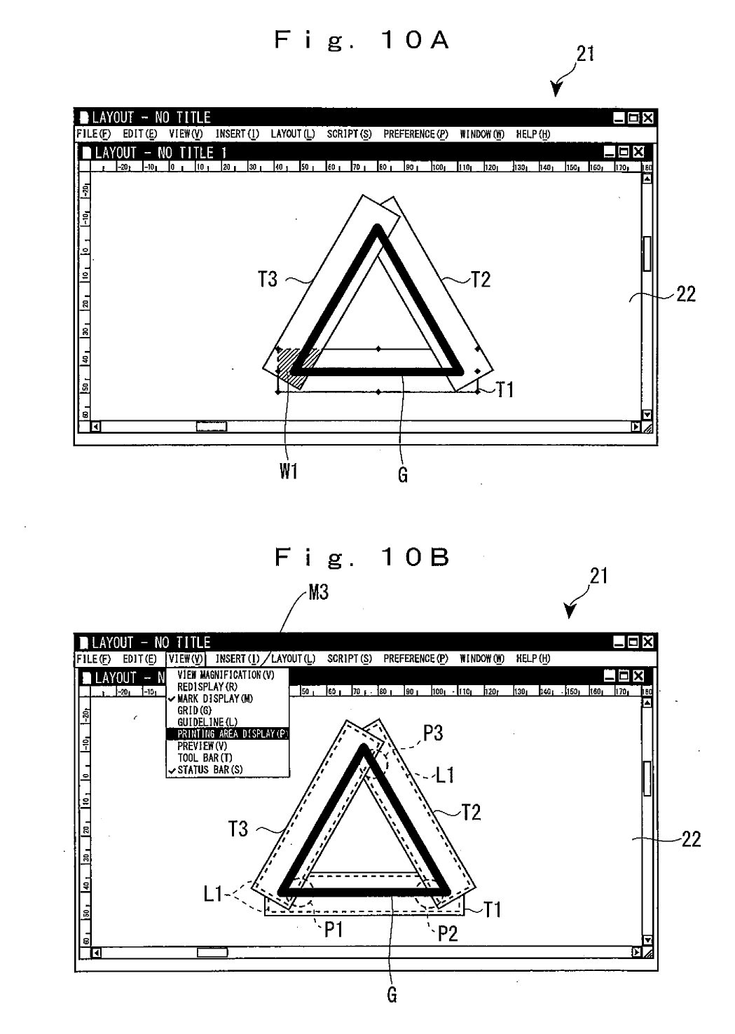

Also, the tape segment T can be edited again after the printed image G is arranged on the tape segment T, as shown in FIG. 10A. An example in FIG. 10A shows a state where the position (arrangement) of the tape segment T1 is adjusted. In addition, the tape width can be changed with the right-click menu M2 at this point, as shown in FIG. 7B. When the tape width is changed (in the case of using tape segments T having a plurality of tape widths), since the tape cartridge C of the tape printing device 3 is needed to be replaced, a message such as “replace the tape cartridge with a tape cartridge with a tape width of xx” is displayed on the editing screen 21 when switching the tape width. Alternatively, the overlapping order of the tape segments T (their positional relationship) can be changed with the right-click menu M2. When the overlapping order of the tape segments T1 and T3 is changed, the change thereof can be performed by double-clicking with the mouse pointer positioned on the overlapped part W1, or displaying the right-click menu M2 with the mouse pointer positioned on the overlapped part W1 to select options for changing the overlapping order.

As shown in FIG. 10B, if the “printed area display” is selected from a display menu M3, a printed area display mode is set to display a print border L1 that displays a boundary between a printable area and an unprintable area of each tape segment T with dotted lines. The “unprintable area” refers to an area where a periphery of the tape segment T cannot be printed, produced, in the tape printing device 3 side, by the configuration of the print processing section 110 and the cutting section 143. Accordingly, the user can edit each tape segment T with recognition of the unprintable area thereof by displaying the print border L1. In the example of FIG. 10B, P2: a part of the unprintable area of the tape segment T2 that is the overlapped part with the tape segment T1, P1: a part of the unprintable area of the tape segment T3 that is the overlapped part with the tape segment T1, P3: a part of the unprintable area of the tape segment T3 that is the overlapped part with the tape segment T2, all of which will miss the outline of the printed image G.

In FIG. 10B, a state where the outline of the image is not missed is shown; however, the formation of the printed image G with the tape segments T is put may be checked by hiding the printed image G that overlaps on the unprintable area (the edge of the print border L1). Alternatively, the printed image G without missing the outline can be of course reproduced by cutting off the unprintable area along the print border L1 from the created tape segment T1.

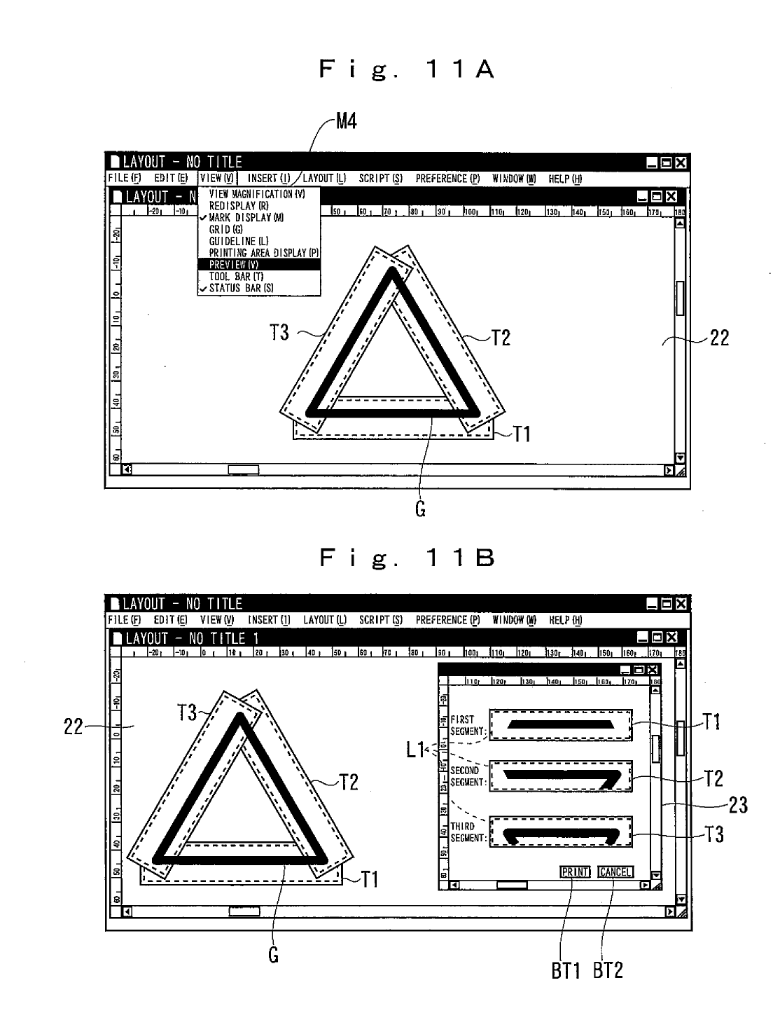

As shown in FIG. 11A, after both the tape segment T and the printed image G have edited, “preview” is selected from a display menu M4 to display a print confirmation screen 23 (preview area) as shown in FIG. 11B. In the print confirmation screen 23, a part of the printed image G is allocated to each tape segment T based on the arrangement of the printed image G and the tape segments T both of which are displayed on the editing area 22 of FIG. 11B to preview the divided image data generated based on the allocation result for each tape segment T. Also in the print confirmation screen 23, the print border L1 indicative of the unprintable area is displayed while the printed image G is not displayed on the edge of the print border L1 (unprintable area)(the actual print result is displayed), regardless of the printed area display mode.

In the print confirmation screen 23 of FIG. 11B, it is shown that the divided image data is output in order of the tape segments T1, T2 and T3. This outputting order is based on the overlapping order of the tape segments T. In other words, if the divided image data is output from the tape segment T positioned at the backmost to the tape printing device 3, since each tape segment T is created according to the outputting order, the user can put the tape segments T together according to the created order. If a print button BT1 is clicked in the lower part of the print confirmation screen 23, printing (outputting the divided image data to the tape printing device 3) is performed, whereas a cancel button BT2 is clicked, the print confirmation screen 23 is closed.

Next, referring to a flowchart of FIG. 12, an image data generating process performed by the image data creating device 2 will be described. The image data generating process is mainly performed by the CPU 16; therefore, the grammatical subject will be appropriately omitted in the description below. When the activation of the PC application 18b is instructed by the keyboard 11 and the mouse 12, the PC application 18b is consequently activated (S01) to display the editing screen 21 (see FIG. 3 etc.) (S02, display unit).

When the printed area editing mode is set with the setting menu M1 in the editing screen 21 (see FIG. 7A) (S03: Yes), then edit processing of the tape segment T (printed area) is performed (S04). In this step, processes such as specification of the arrangement angle of the tape segment T (tape-arrangement specifying unit) and change of the overlapping order of the tape segments T (overlap reordering unit) are performed.

The edit processing of the printed image G (e.g. characters and graphics) is sequentially performed (S05). In this step, a part of the printed image G is allocated to each tape segment T by overlapping and arranging the printed image G on a plurality of tape segments T (printed image allocating unit). After the tape segment T and the printed image G have edited, the preview mode is set with the display menu M4 (see FIG. 11A) to display a preview (S06, display unit). In this step, a plurality of divided image data is generated (divided image data generating unit) to be printed on a plurality of tape segments T based on the edit result in S04 and S05 to display each of the divided image data on the print confirmation screen 23 for each tape segment T.

The user checks the preview, and if it is OK, print is instructed by pressing the print button BT1 (see FIG. 11B) (S07: Yes, print instructing unit). If print processing on the preview is not performed (S07: No), the edit processing continues by pressing the cancel button BT2 (see FIG. 11B).

When the print is instructed (S07: Yes,), the generated plurality of divided image data is output to the tape printing device 3 (S08, divided image data outputting unit) to complete the processing. On the other hand, if the printed area editing mode is not set with the setting menu M1 (see FIG. 7A) (S03: No), only the printed image G is edited (S09) to output the divided image data based on the edit result without editing the tape segment T (S07).

As described above, according to the image data creating device 2 of the embodiment, since the user can set the arrangement angle of each tape segment T while checking the state where the printed image G and a plurality of tape segments T are overlapped and arranged on the display 13, even when a triangular or circular printed image G is formed by putting a plurality of tape segments T together on each other, waste tape can be reduced by arranging each tape segment T along the outline of the printed image G. This allows to represent the image area with the tape segment T, thereby easily accomplishing a wide variety of examples of how to put tage segments together. That is, what is shown in FIG. 9A is unfeasible with the tape printing device can be accomplished by representing a triangle only with the tape segments T.

Furthermore, the image data creating device 2 can specify not only the arrangement angle of each tape segment T, but also the tape length of each tape segment T, the tape printing device 3 can create the tape segments T by cutting not the tape segment T that is cut into a predetermined length in advance, but the elongated tape since the divided image data to output to the tape printing device 3 includes the data to instruct to cut the tape segment. This allows to create a tape segment T in any length to accomplish a wider variety of examples of how to put tape segments together. Furthermore, since, with the right-click menu, the overlapping order of the overlapped part of the tape segments T can be changed, or the tape width can be specified, they can be put together according to the user preference.

In addition, since the print confirmation screen 23 displays the print preview for each tape segment after editing the tape segments T and the printed image G, the user can check to which part of the printed image G each tape segment T corresponds and distinguish between the top and the bottom of the tape segment T, thus such tape segments can be easily put together with the image data creating device 2. Since the print border L1 of each tape segment T is displayed on the print confirmation screen 23 and the editing area 22, the user can recognize beforehand that a part of the printed image G over the unprintable area of each tape segment T is missed to specify the arrangement of each tape segment T.

Also, if a part of a plurality of tape segments T is specified to be overlappingly arranged, the image data creating device 2 outputs each divided image data to the tape printing device 3 according to the overlapping order of the overlapped part thereof, therefore, the user can put tape segments together in the printing order. This allows to shorten a waiting time since there is no need to wait to print all tape segments T and put such tape segments together in the correct order, whereby the problem in that the desired printed image G cannot be reproduced because of the erroneous order to put tape segments together can be solved.

In the above embodiment, it is preferred that information to discriminate among each tape segment T is displayed on the editing area 22 and the print confirmation screen 23 so that tape segments T displayed on the editing area 22 and the tape segments T displayed on the print confirmation screen 23 can be easily identified. In this case, each tape segment T may be automatically given a tape number or displayed in different colors according to the creating order or the outputting order of the tape segments T.

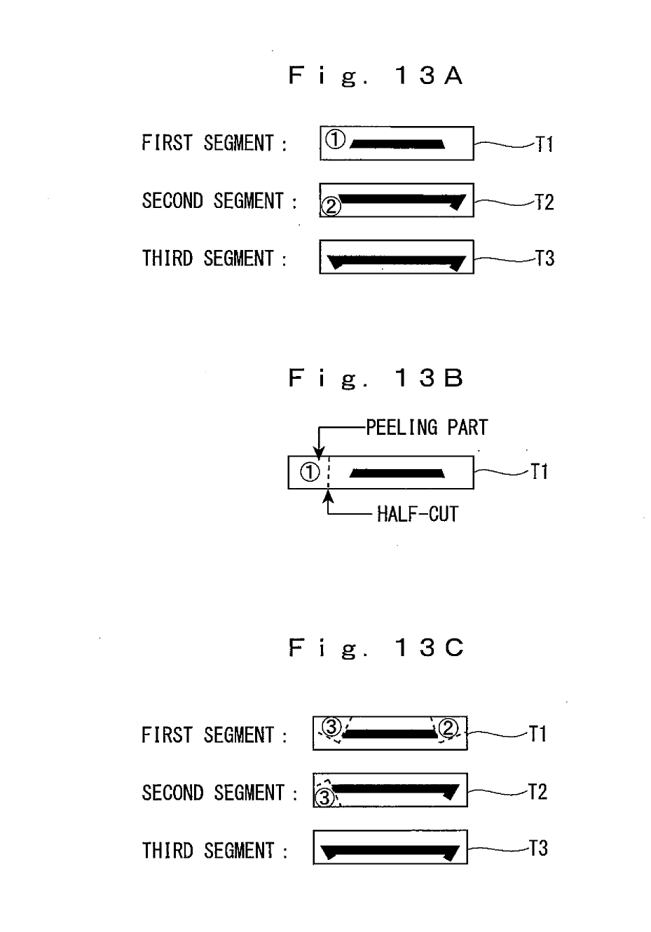

Alternatively, the tape number may be printed on the tape segments T to facilitate the applying operation. In this case, as shown in FIG. 13A, as for the tape segment T having an area hidden by the overlapped part of the respective tape segments T (in the example of FIG. 13A, tape segments T1 and T2), the tape number of the tape segments T may be printed on the hidden area. In addition, if the tape printing device 3 has a peeling part adding function that adds a peeling part by cutting the peripheral edge of the tape segment T in half to facilitate peeling of the tape, the tape number may be printed on the peeling part, as shown in FIG. 13B. As shown in FIG. 13C, a guideline L2 for applying the tape segment T to overlap with another tape segment T and the tape number of the overlapping tape segment T are printed on the overlapped tape segment T, resulting in more attractive application result.

Furthermore, in the above embodiment, although the outputting order of the divided image data is determined based on the overlapping order of the tape segments T, the outputting order may be determined according to the editing order of the tape segments T, the arrangement thereof or the like, regardless of the overlapping order.

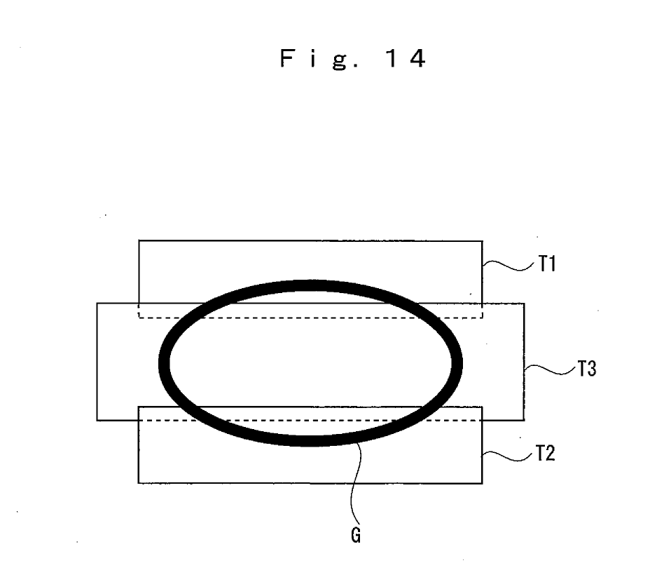

Alternatively, not only the overlapping of the tape segments T, but also the tape width may be taken into account (giving priority to the tape width) to determine the outputting order. FIG. 14 shows an application result in a case where an enlarged printed image G is formed with the tape segments T1 and T2 having the same tape width and the tape segment T3 having a different tape width from the tape segments T1 and T2. In this example, assuming that the divided image data is output based only on the overlapping order of the tape segments T, the tape segments T1, T3 and T2 are output in this order. If priority is given to output by the tape width, the tape segments T1, T2 and T3 are output in this order. This allows to reduce the number of replacement of the tape cartridge C, thereby reducing the user's involvement.

As described above, it is preferable that, when the divided image data is output by the tape width, an informing unit (display, audio guidance, etc.) that informs of switching the tape width on switching is mounted on the image data creating device 2. With this configuration, the tape cartridge C of the tape printing device 3 may be replaced according to information such as “next, replace the tape cartridge with a tape cartridge with a tape width of xx mm”, therefore convenient on the printing operation.

Moreover, the PC application 18b shown in the above embodiment can be provided as a computer program. Alternatively, the program can be stored in a various storage medium (CD-ROM, flash memory, etc.) to be provided. That is, the PC application 18b itself, and the storage medium storing therein are also included in the scope of the invention.

In addition, although the above embodiment is configured as the printing system 1, the tape printing device 3 may have the function of the PC application 18b and be used as a single unit to perform the edit processing or the print processing of the tape segments T and the printed image G. Changes can be appropriately made within the scope of the gist of the invention.

What is claimed is:

1. An image data generating device comprising:
the image data generating device that generates a plurality of pieces of divided image data to be printed on each tape segment to form a printed image by putting a plurality of tape segments together on which a divided printed image being a part of the printed image larger than the width of each tape segment is printed,
a display unit that displays a state where the printed image and the plurality of tape segments are overlapped and arranged;
a tape-arrangement specifying unit that specifies an arrangement angle of the each tape segment displayed on the display unit;
a printed image allocating unit that allocates the divided printed image to each tape segment based on a specification made by the tape-arrangement specifying unit; and
a divided image data generating unit that generates a plurality of divided image data based on a result allocated by the printed image allocating unit.

2. The image data generating device according to claim 1, wherein the tape-arrangement specifying unit is capable of specifying the arrangement angle of each tape segment and the tape length of each tape segment, and the tape segment is prepared by printing on and cutting an elongated tape based on the divided image data including information on the specified tape length.

3. The image data generating device according to claim 1, wherein the display unit includes a preview area that previews a result generated by the divided image data generating unit for each tape segment.

4. The image data generating device according to claim 1, wherein the tape-arrangement specifying unit includes an overlap reordering unit that changes, when a part of the plurality of tape segments is specified to be overlappingly arranged, the overlapping order of the overlapped part thereof by the specification of an overlapped part.

5. The image data generating device according to claim 1, wherein the display unit displays a border between a printable area and an unprintable area of each tape segment.

6. The image data generating device according to claim 1, further comprising:
a print instructing unit that instructs to print the plurality of divided image data generated by the divided image data generating unit; and
a divided image data outputting unit that outputs the plurality of divided image data according to an instruction made by the print instructing unit.

7. The image data generating device according to claim 6, wherein, when a part of the plurality of tape segments is specified to be overlappingly arranged by the tape-arrangement specifying unit, the divided image data outputting unit determines an outputting order of the divided image data according to the overlapping order of overlapped parts of the tape segments.

8. The image data generating device according to claim 6, wherein the tape-arrangement specifying unit is capable of specifying the arrangement angle of each tape segment and the tape width of each tape segment; and
the divided image data outputting unit includes a tape switching informing unit that determines the outputting order of the divided image data according to the tape width specified by the tape-arrangement specifying unit and informs that the tape width of the divided image data output by the divided image data outputting unit is switched, when switching the tape width.

9. A tape printer that creates a plurality of tape segments based on a plurality of divided image data generated by the image data generating device as claimed in claim 1.

10. A printing system comprising:
the image data generating device as claimed in claim 1; and
a tape printer that creates the plurality of tape segments based on the plurality of divided image data generated by the image data generating device.

11. A computer program that causes a computer to function as each unit in the image data generating device as claimed in claim 1.
